(19) United States
(12) Patent Application Publication
(10) Pub. No.: US 2021/0359767 A1
(43) Pub. Date: Nov. 18, 2021

(54) METHOD AND SYSTEM FOR DETERMINING SEPARATION OF A PLURALITY OF MOVING OBJECTS

(71) Applicant: M2MD Technologies Inc., Atlanta, GA (US)

(72) Inventor: Charles M. Link, II, Atlanta, GA (US)

(21) Appl. No.: 17/320,140

(22) Filed: May 13, 2021

Related U.S. Application Data
(60) Provisional application No. 63/025,121, filed on May 14, 2020.

(51) Int. Cl. H04B 11/00; H04W 4/029; H04W 4/02; G01S 15/10

(52) U.S. Cl. CPC H04B 11/00; H04W 4/029; G01S 15/101; G01S 15/102; H04W 4/023

(57) ABSTRACT

Each of a plurality of tracking/proximity devices periodically transmits an acoustic message signal and an electronic/Bluetooth message signal and receives the same from the other devices. Each of the devices determines the proximity/separation/distance to/from/between the others by assuming that the receipt time of an electronic message signal equals its transmission time and that the receipt time of the corresponding acoustic message signal minus the receipt time of the electronic message signal equals the amount of time that the acoustic signal traveled from the transmission device to the receiving device. The receiving device converts the acoustic signal travel time into a distance by multiplying by the speed of sound. Thus, the receiving device determines the distance to the transmitting device and may alert a server, user, or wearer of the determined distance, or merely that the determined distance is less than a configurable predetermined amount.

### CROSS REFERENCE TO RELATED APPLICATION

This application claims priority under 35 U.S.C. 119(e) to U.S. provisional patent application No. 63/025,121 “Method and system for determining separation of a plurality of moving objects,” which was filed May 14, 2020, and which is incorporated herein by reference in its entirety.

### FIELD

The present invention relates to location-determining devices, and more particularly to determining the proximity of one location-determining device to another in an environment where the devices are typically moving with respect to one another.

### BACKGROUND

Electronic wireless communications devices serve many purposes in today's connected world. In addition to providing communication between people using such devices, wireless communications devices may use sensors to provide information regarding the environment surrounding the device to a user. Such information may be provided wirelessly to another wireless communication device, such as a user equipment device (“UE”). Examples of user equipment devices include smart phones, tablets, smart watches, and the like. Information that may be provided to a UE includes the location of the device that is providing the information.

In addition to UE devices, less-complicated devices such as tracking devices and electronic tag devices may also communicate wirelessly with one another or as slave devices to a master device, such as a handheld wireless UE device, or with a fixed device that may be connected by one or more conductors to a wireless access point device.

Affixing a particular electronic wireless device to, or associating a particular wireless device with, a particle user may facilitate determining proximity to a particular, or non-particular, other device or person associated therewith.

### SUMMARY

A method and system is described for using low cost communication devices that include Bluetooth transceivers and ultrasonic transceivers, preferably four (or more in an aspect) ultrasonic transceivers at each corner of a four-corner device such that anatomy of a wearer of the low cost device does not impede an acoustic path of an ultrasonic acoustic signal to at least one of the ultrasonic transducers. In an aspect, a processor of the low-cost device may periodically cause test signals to be emitted from each of the ultrasonic transducers to determine from reflections received thereby one or more of the ultrasonic transducers that are not impeded, or that are minimally impeded, by a wearer's anatomy (e.g., the neck if a wearer is wearing the low-cost device on his shoulder), and may reduce gain from the most impeded ultrasonic sensors.

The low-cost devices each transmit the same, or similar, messages simultaneously from both the Bluetooth transceiver and the ultrasonic transceiver. Because the Bluetooth signal travels at approximately, if not exactly, at the speed of light, the message sent via Bluetooth arrives substantially sooner than the ultrasonic acoustic signal. A receiving device of a plurality of the devices (which may all be periodically simultaneously transmitting electronic and acoustic message) assumes that the transmit time of both message signals is the time of arrival, or receipt time, of the electronic message and calculated the travel time of the acoustic signal by subtracting the arrival time of the electronic message signal from the arrival time of the acoustic message signal. The messages contained in the signals may include an identifier of the transmitting device that uniquely identifies said transmitting message. Thus, the receiving device can determine that it is too close (based on a predetermined separation range) to the transmitting device and may alert the wearer of the receiving device of the breach of the separation range of the other device.

### BRIEF DESCRIPTION OF THE DRAWINGS

FIG. 1 illustrates a floorplan of a warehouse or light industrial facility.

FIG. 2 illustrates a scenario where a first electronic device transmits identification information via a short-range wireless signal and via an acoustic transducer, and where a second electronic device receives both signals and calculates a distance between the first and second electronic devices.

FIG. 3 illustrates a block diagram of an electronic communication device that can transmit and receive wireless electronic and acoustic signals.

FIG. 4 illustrates a particular electronic device receiving wireless electronic signals and corresponding acoustic signals from multiple other electronic devices.

FIG. 4B illustrates message contents of an electronic signal and an acoustic signal.

FIGS. 5A and 5B illustrate a flow diagram of a method for determining the distance between two or more electronic devices and for providing indications when one or more of the devices is within a predetermined range.

### DETAILED DESCRIPTION OF THE DRAWINGS

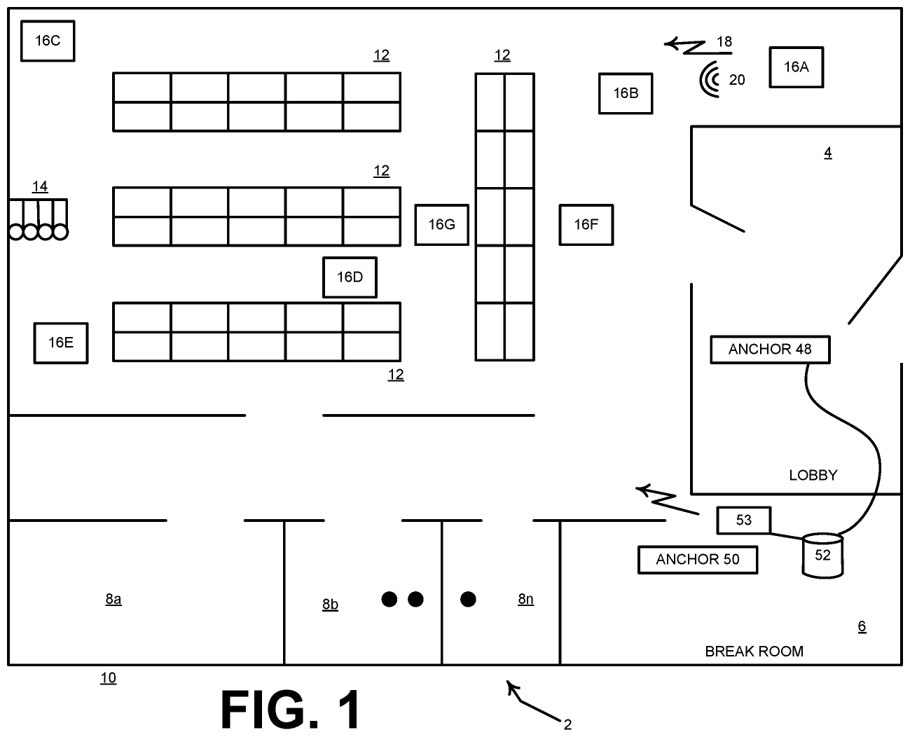

Turning now to the figures, FIG. 1 illustrates floorplan of a warehouse or light industrial facility 2. Warehouse 2 is shown with lobby 4 and breakroom 6. Warehouse 2 includes offices 8a-8n and main storage area 10. Main storage area 10 includes storage shelves or spaces 12 and conveyor belt 14. Warehouse 2 is shown with anchor electronic communication device 48 in lobby 4 and anchor electronic communication device 50 in breakroom 6, each of which anchor devices are shown connected to central computer server 52, which is shown connected to a wireless access point device 53, such as a wi-fi hot spot, a Bluetooth transceiver device, a long range wireless communication device, such as a cellular smartphone, Ethernet WAN/LAN, Fiber IP network, and the like.

Mobile electronic communication devices 16A-G are shown at various locations throughout main storage area 10. It will be appreciated that electronic devices 16 may be smartphones, smart watches, or other similar devices that are typically carried by, or on, a person. Electronic communication devices 16 may also be devices that are less complicated than a smart phone, for example the electronic communication devices may be tracking devices, or similar, that includes a processor, an audio receive and transmit portion, and a short-range wireless transceiver portion, which may be a wi-fi transceiver, a Bluetooth transceiver, or other transceiver that can transmit and receive electronic information signals according to a short-range wireless protocol, standard, or technique.

As persons to whom electronic communication devices 16 are attached to, or otherwise particularly associated with, move around in warehouse 2, it may be desirable to provide a warning or an alert to a user of a given device 16 that the person wearing or otherwise associated with the device is within a predetermined range of another person with another device 16 that is particularly associated with that other person. Devices 16 may be configured to periodically substantially simultaneously transmit an electronic message signal and an acoustic information message signal, (such simultaneously transmitted electronic and corresponding acoustic message signals may be referred to as a message couple) where an information message in each of both the electronic and acoustic version includes substantially the same information. For example, an information message signal message may include a trigger signal waveform and an identifier that uniquely corresponds to the device that is sending the message signal. In an aspect, an electronic message signal may be transmitted a predetermined amount of time before, or after, a corresponding acoustic message signal—if the messages are transmitted at a given rate that is known to receiving devices an algorithm residing in a given receiving device can account for a difference in transmit times between electronic and acoustic message signals and determine a distance between the transmitting and receiving devices as discussed in more detail below.

The trigger signal form may include a generic signal form, such as a square-shaped voltage pulse form, wherein the leading edge of the voltage pulse may be used to establish a time of receipt to of the electronic signal at another device 16 that receives the transmitted information message signal. The acoustic information message signal also includes similar, if not substantially identical, information such as the trigger signal form and the unique identifier information of the transmitting device. The trigger signal form transmitted in the acoustic signal may be used by the receiving device to establish a time of receipt t₁ of the acoustic information message signal.

Since information, including trigger form and identifier information, is substantially the same in the electronic and acoustic versions of the information message signals, and because the electronic and acoustic versions are transmitted substantially at the same time (both typically may not be transmitted at exactly the same time by a device having a single processor, which may be descriptive of low-cost, low complexity devices as compared to a smartphone), the receiving device can calculate the distance to the transmitting device when the electronic and acoustic versions were transmitted, based on the speed of sound and based on respective times t₁-t₀ in terms of seconds.

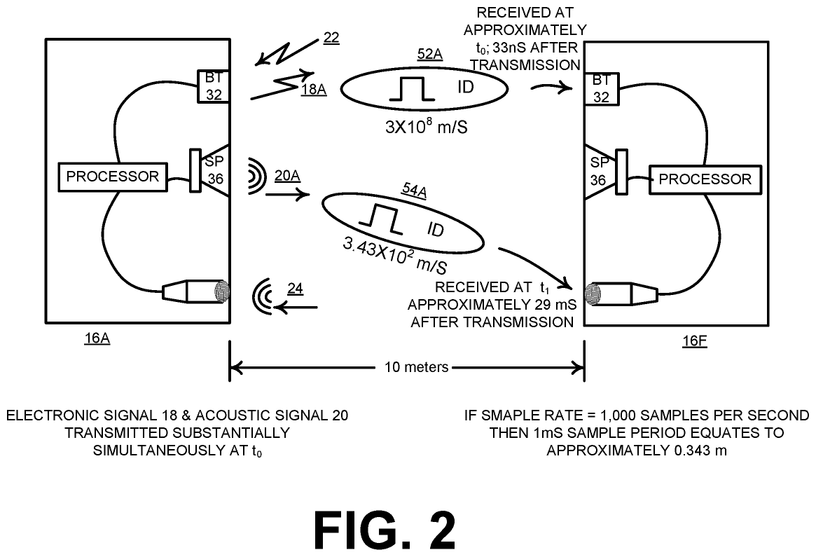

Turning now to FIG. 2, the figure illustrates a warehouse 2, or other similar space, where it may be desirable to provide an indication to a user, or wearer, of a first device that a user, or wearer, of a second device is within a predetermined range. Such a desire may stem from a requirement to maintain a predetermined amount of distance between individuals such that spread of various disease, such as respiratory viruses, is minimized. By implementing a system as illustrated in FIG. 2, an operator of an establishment, such as a shipping warehouse, a restaurant, a sports area, a park, and myriad other types of establishments or attractions may be able to provide compliance with government suggested, or required, ‘social distancing’ guidelines to its employees or customers. Furthermore, implementing a system as shown and described herein is accomplished without synchronicity between system clocks of devices 16A and 16F shown in FIG. 2.

In FIG. 2, devices 16A and 16F are shown and described in reference to the devices having the same reference numbers as shown in FIG. 1. It will be appreciated that both devices 16 (as well as other devices 16 shown in FIG. 1) may periodically emit an electronic version and an acoustic version of a given message. The period at which devices 16 emit their respective electronic and acoustic messages may be configurable, and each device 16 shown in FIG. 1 or FIG. 2 need not emit information massages at the same periodic interval. For purposes of discussion, it may be assumed that all devices 16 shown in FIG. 1 emit an electronic message and a corresponding acoustic message at a rate having about a 1 second period, or interval between transmitting of signals.

In FIG. 1, device 16 A is shown in the upper right-hand corner of storage area 10 and device 16 F is shown located between lobby 4 and the first storage shelf 12 to the left of the lobby area. As shown in FIG. 2 this distance corresponds to approximately ten meters, or 10 m. It will be appreciated that FIG. 1 is meant to illustrate a snapshot-in-time and the users, or wearers, of devices 16 are presumed to me constantly in motion and may not remain in the locations shown. In fact, any, or all, of devices 16 as shown in FIG. 1 may be in motion.

In FIG. 2, device 16A is shown emitting an electronic message 52A via electric signal 18A and emitting acoustic message 54A via acoustic signal 20A. Device 16A is also shown receiving an electronic message signal 22 and an acoustic signal 24, either or both of which may have been transmitted from device 16F, or from any of devices 16B, 16C, 16D, 16E, or 16G.

At the snapshot in time shown in FIG. 1, FIG. 2 shows the distance between devices 16A and 16F being 10 m apart when device 16A transmits messages 52A and 54A via signals 18A and 20A, respectively, substantially simultaneously. In an aspect, electronic message signal 18A may be transmitted via a short-range wireless Bluetooth link (the electronic signal and electronic signal link may be referred to herein by the same reference number, such as 18A, for purposes of convenience) from a Bluetooth module 32 of device 16a. In an aspect, acoustic message 54A may be transmitted from speaker 36.

Electronic signal 18A travels at approximately the speed of light, which is approximately 3×10⁸ msec, and acoustic signal 20A, upon emission from speaker 36, travels at approximately 3.43×10² msec. Thus, device 16F receives electronic signal 18A approximately 33.3×10⁹ sec, or 33.3 nanoseconds (“nS”) after transmission by device 16A. For all practical purposes, any other of devices 16 shown in FIG. 1 receives electronic signal 18A 33.3 nS after transmission by device 16A, although it will be appreciated that devices that are different distances from device 16A than that of device 16F will receive electronic signal 18A either very slightly sooner or very slightly later than device 16F receives the same signal, depending on whether the other receiving devices are closer, or farther, respectively, from device 16A than is device 16F.

On the other hand, device 16F receives acoustic signal 20A approximately 29.2 milliseconds (“mS”) after transmission from device 16A, but devices other than 16F may receive acoustic signal 20A at times that are not substantially 29.2 mS after transmission from device 16A.

In an aspect, each of devices 16 are programmed to establish the receipt time of an electronic signal 16 as time t₀ and to determine when it has received an acoustic signal from the same devices that sent the given electronic signal based on a unique identifier conveyed within messages of both the electronic signal and the acoustic signal. For purposes of discussion, the receipt time of the acoustic signal corresponding to the receipt of a given electronic signal may be deemed as t₁. In the example illustrated in FIG. 2, to =33.3 nS and t₁=29.2 mS, or to =33.3×10⁹ S and t₁=29.2×10⁶ S. For purposes of discussion of FIG. 2, the distance from device 16A to device 16B is assumed to be 10 meters to show what the time difference is between to and t₁. However, since the purpose of this aspect is to determine an unknown distance, device 16F determines the Δt (i.e., t₁−t₀) between receipt time of signals 20A and 18A and uses the speed of sound in air to calculate the distance between devices 16F and 16A.

Since sound travels 343 m/sec in air, it follows that sound travels 0.343 m/mS. Thus, if device 16F uses a sample rate of 1,000 samples per second, each sample would equate to 0.343 meters, which is approximately 13.5 inches. Thus, the accuracy of a device processing the signal trigger form in signal message 54A would be slightly more than one foot. Similarly, if the sample rate of a signal processing application running on device 16F were increased to 10,000 samples per second, device 16F could then determine the distance to device 16A by processing the trigger form in message 54A to within 1.35 inches. If a processor of a receiving device 16 has a processor clock speed that facilitates a signal sample rate of 10,000, a given device 16 could determine the distance to another device 16 to within less than 2 inches, which should meet most government and private sector requirements for social distancing monitoring.

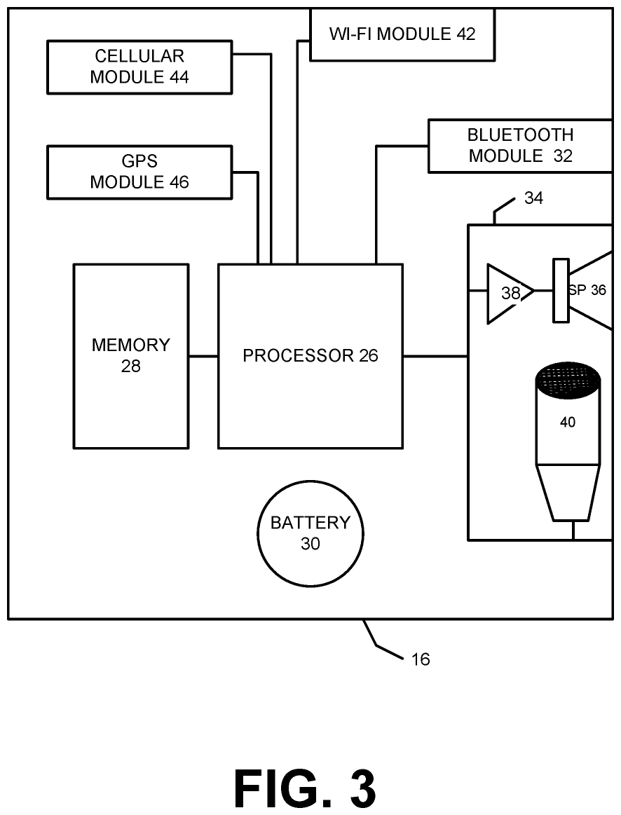

Turning now to FIG. 3, The figure illustrates a block diagram of components of a low-cost tracking device, or proximity device, 16. Device 16 includes a battery that may provide power to one or more of the components of the device. Device 16 includes a processor 26 that is coupled to a Wi-Fi module 42, a cellular phone/data module44, and a GPS module 46. Processor 26 has access to memory 28, which may be part of processor 26 or may be separate from processor 26. Memory 28 may be a memory portion of a SIM card of device 16, or may be a SIM profile that is stored on a memory portion of device 16 that is not part of a SIM card. Processor 26 also couples to Bluetooth transceiver module 32 and acoustic transceiver module 34. Acoustic module 34 maybe an ultrasonic acoustic module. Module 34 may be a transceiver that includes speaker 36 driven by amplifier 38, and module 34 may include microphone 40. It will be appreciated that symbols for a speaker and a microphone are used to represent that module 34 can produce acoustic tones from speaker 36 and it can receive acoustic tones with microphone 40. However, an acoustic sensor that detect ultrasonic tones may not necessarily be properly characterized as a microphone, and an emitter of ultrasonic tones may not necessarily properly be characterized as a speaker. The symbols are merely shown to represent that module 34 produces sound as directed by processor 26 and receives sound, whether audible, or outside audible range, for forwarding to processor. Processor 26 may cause Bluetooth transceiver module 32 and ultrasonic transducer 36 to both transmit a message simultaneously, wherein the message includes identifier information than uniquely identifies device 16. The transmitted messages may also include a trigger, or detectable beginning point such as a signal pulse, for a receiving device to use in establishing the time that the receiving device receives the acoustic message or the electronic/ultrasonic message. The acoustic message may be transmitted using phase shift keying (“PSK”), On-Off Keying (“OOK”), Frequency Shift Keying (“FSK”), or other acoustic/audio techniques that facilitate transmitting a signal form for which a trigger/indication may be determined by a receiving device and for which can be transmitted acoustically in a given desired frequency range, such as an ultrasonic range.

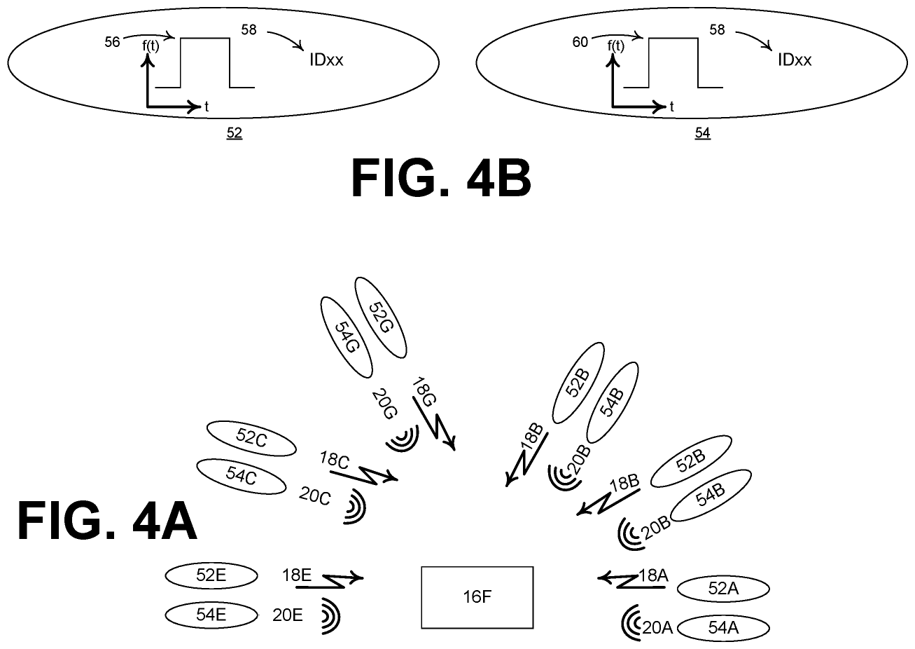

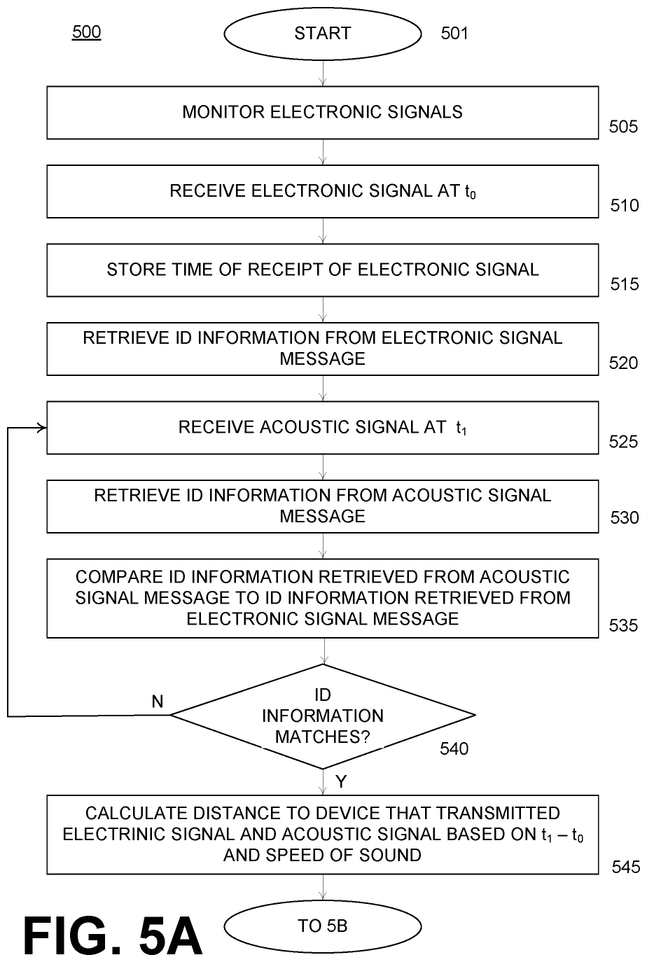

Turning now to FIG. 4A, the figure illustrates a particular electronic device 16F (as shown located in storage are 10 in FIG. 1) receiving wireless electronic signals 18A, 18B, 18C, 18D, 18E, and 18G and corresponding acoustic signals 20A, 20B, 20C, 20D, 20E, and 20G from multiple other electronic devices 16A, 16B, 16C, 16D, 16E, and 16G, respectively. Electronic signals 18A, 18B, 18C, 18D, 18E, and 18G and corresponding acoustic signals 20A, 20B, 20C, 20D, 20E, and 20G are shown carrying corresponding electronic message 52A, 52B, 52C, 52D, 52E, and 52G and corresponding acoustic messages 54A, 54B, 54C, 54D, 54E, and 54G, respectively.

Turning now to FIG. 4B, the figure illustrates information carried in an example electronic message 52, which information includes initial electronic signal indication 56 and transmit device identifier information 58 that corresponds to the device that transmitted the electronic signal. FIG. 4B also illustrates information carried in an example acoustic message 54, which information includes initial acoustic signal indication 60 and transmit device identifier information 58 that corresponds to the device that transmitted the electronic signal. It will be appreciated that the transmit device identifier information 58 is substantially the same in electronic message 52 and acoustic message 54. It will also be appreciated that the electronic signal and acoustic signal may be referred to as an electronic presence signal and an acoustic presence signal, respectively. It will be appreciated that reference herein, including in the Claims, to an electronic signal or acoustic signal may be deemed as a reference to the respective signals as including an electronic message and the content it carries or to an acoustic message and the content it carries, as described in reference to FIG. 4B, for example.

Continuing with discussion of FIG. 4B, electronic message 52 is illustrated as including in its contents a presence signal indication 56. In the figure, the arrow is shown pointing to the trailing edge of a square pulse signal form. Such a signal form could include, for example, a pulse of energy that exceeds a predetermined voltage, or that represents a change in voltage from a previous voltage of electronic signal 52. It will be appreciated that other indication forms could be used, including: a leading edge of a signal pulse, the peak of a saw-tooth wave form, the passing through a predetermined voltage level after the signal form exceeds a different predetermined voltage level, a predetermined sequence of bits, and the like.

Electronic message 52 is also shown including an identifier 58 that is uniquely associated with, and uniquely corresponds to, the device that transmitted the message. Such an identifier 58 may include information such as a MAC address, an IMSI, a MIN, a Bluetooth module serial number (which may be uniquely associated with Bluetooth module 32 shown in FIG. 3), a Bluetooth friendly name (which also may be uniquely associated with Bluetooth module 32 shown in FIG. 3), a Wi-Fi access point identifier, and the like.

Acoustic message 54 is illustrated as including in its contents a presence signal indication 60. In the figure, the arrow is shown pointing to the trailing edge of a square pulse signal form. Such a signal form could include, for example, a pulse of energy that exceeds a predetermined voltage, or that represents a change in voltage from a previous amplitude of acoustic signal 54. It will be appreciated that other indication forms could be used, including: a leading edge of a signal pulse, the peak of a saw-tooth wave form, the passing through a predetermined voltage after the signal form exceeds a different predetermined voltage level, a predetermined sequence of bits, and the like.

Electronic message 54 is also shown including an identifier 58 that is uniquely associated with, and uniquely corresponds to, the device that transmitted the message. Such an identifier 58 is the same as the identifier includes in message 52, and as discussed above in reference to message 52, identifier 58 may include information such as a MAC address, an IMSI, a MIN, a Bluetooth module serial number (which may be uniquely associated with Bluetooth module 32 shown in FIG. 3), a Bluetooth friendly name (which also may be uniquely associated with Bluetooth module 32 shown in FIG. 3), a Wi-Fi access point identifier, and the like.

For purposes of discussion it is assumed that identifier 58 contains as identification information in electronic message 52 and in acoustic message 54 a friendly name of a Bluetooth module 32 of device 16A, the friendly name itself being ‘16A’ in the example. Also for purposes of discussion, assume that signal forms 56 and 60 as shown in FIG. 4B are square pulse forms, each having the same predetermined duration. The trailing edges of forms 56 and 60 may be viewed as ‘triggers,’ or as marking the beginning of electronic message 52 and acoustic message 54, respectively. As discussed above, device 16A (and other devices 16) transmits messages 52 and 54 as close to simultaneously as possible (typically within a few nanoseconds, depending upon the processor clock speed at which a processor of device 16F is operating). Thus, when device 16F receives electronic message 52, which receipt will occur substantially before receipt of message 54 due to the speed of light being substantially faster than the speed of sound, a processor of device 16F establishes the time at which it processes trailing edge 56 as time t₀. In an aspect introduced above in the discussion of FIG. 1, an electronic message signal may be transmitted before or after a corresponding acoustic message. If the receiving device knows, or is programmed with, the difference in transmit times for the electronic and acoustic message signal couples of a given transmitting device, the receiving device can use a value representing this difference to determine the time it took for the acoustic message to reach the receiving device from the transmitting device. For example, if a given transmitting device transmits an acoustic message signal 100 mS after transmitting a corresponding electronic message signal, and a processor of the receiving device determines that it received the acoustic message signal 139 mS after it received the corresponding electronic message signal, the processor of the transmitting device may determine that 39 mS elapsed from the time that the acoustic signal was transmitted by the transmitting device to the time the acoustic message signal was received by the receiving device. (This is based on the assumption that the time that the receiving device receives an electronic message signal is the same, or substantially the same, as the time the transmitting device transmittd the electronic message signal.)

The processor of device 16F also associates to with the device identified in identification information 58 in a memory of device 16F. (The memory could be a stand-alone memory 28 as shown in FIG. 3, part of processor 26, part of a SIM card memory, or part of a SIM profile that is a portion of the stand-alone memory or another memory that is not part of a SIM card.) As shown in FIG. 4A, device 16F has multiple electronic messages 52 and multiple acoustic message 54 impinging on its electronic message transceiver, such as Bluetooth module 32, and its acoustic transducer 40 (e.g., a microphone or other transducer that is capable of detecting acoustic signals in a predetermined frequency range, such as ultrasonic range, for example). The processor of device 16F processes all of messages 52 and 54 as it receives them, and stores indication times 56 and 60 as receipt indications in association with corresponding identifier information 58 contained in messages 52 and 54 that it receives. When the processor of device 16F determines that an acoustic message 54 contains an identifier 58 that matches a previously processed and unmatched identifier 58 from a previously received electronic message 52, the processor of device 16F establishes the time that it processed indication 60 in the acoustic message as t₁. It will be appreciated that times to and t₁ are determined in reference to an internal clock of device 16F and thus do not depend on a time stamp being generated by the transmitting device or being included in the messages 52 or 54.

It will be appreciated that multiple devices 16 in a given environment, such as warehouse 2 shown in FIG. 1, may have a configurable transmit rate (i.e., rate that a given device transmits electronic signals 52 and acoustic signals 54). Thus, a given device that has received electronic and acoustic messages may deem an electronic message as discardable if it is unmatched with a corresponding acoustic message (i.e., has the same identifier 58) that has a receipt indication time 60 as corresponding to a distance less than sound can travel within the entire environment during a predetermined period, such as the configurable transmit rate. In other words, if there is no acoustic message with a receive time t₁ that differs from the to of the electronic message being evaluated such that t₁−t₀ could correspond to a straight line distance within warehouse 2, then the electronic message is discardable. This avoids a situation where an electronic message is received but the corresponding acoustic message is not received due to noise, acoustic barriers (such as walls) attenuating the signal, or the transmit device being far enough away from the receiving device such that the acoustic signal is attenuated more than the corresponding electronic signal was.

Similarly, a given device that has received electronic and acoustic messages may deem an acoustic message as discardable if it is unmatched with a corresponding electronic message that has a receipt indication time 56 relative to the indication time 60 of the acoustic message such that the difference in indication times established by indications 56 and 60 corresponds to a distance less than sound can travel within the entire environment warehouse environment 2 during a predetermined period, such as the configurable transmit rate. This avoids a situation where an acoustic message is received but the corresponding electronic message was not earlier-received due to noise, electronic barriers (such as metallic objects) attenuating the signal, or the transmit device being far enough away from the receiving device such that the electronic signal is attenuated more than the corresponding acoustic signal was.

When device 16F determines that a non-discardable acoustic signal 54 is found to match a previously received electronic signal 52, the processor of device 16F determines the difference in time corresponding to the different receipt indications 60 and 56 for the matched signals. Such a determination may be a simple subtraction calculation where the time of receipt corresponding to the processing of indication form 56 is subtracted from the time of receipt corresponding to the processing of indication form 60. If the time of indication 56 is labeled as t₀ and the time of indication 60 is labeled t₁, the calculation would be t₁−t₀=t_{d}, where t_{d} is the time for an acoustic signal to travel from the transmitting device to the device 16F. After determining t_{d}, the processor of device 16F can convert t_{d} into a distance based on the speed of sound by multiplying the speed of sound by t_{d}. For example, if device 16F determines that t_{d} for corresponding electronic and acoustic messages transmitted from device 16A is 0.010 S, or 10 mS, device 16F may determine that when device 16A transmitted the current messages 52 and 54 being evaluated device 16A was 3.34 m from device 16F, which distance is approximately 10 feet. It will be appreciated that for purposes of determining the separation of human beings relative to a requirement that people stay a certain number of meters, or feet, apart (for example due to minimum social distancing requirements of, for example 6 feet), assuming that the receipt indication 56 of electronic message 52 is acceptable because the amount of time for an electronic message to travel from one device to another, even at a distance of 1,000 meters, is only 3.33×10⁻⁶ S, or 3.33 μS. When using the speed of sound as a basis for determining the separation distance between a receiving device and a transmitting device, 3.33 μS equates to only 1.1 mm, which for purposes of determining social distancing separation is negligible. Therefore, comparing receipt times based on a clock local to a receiving device and based on differences in travel speed of electronic messages and acoustic message, avoids complexity by not requiring that a transmitting device 16 include a time stamp in messages 52 and 54, and by not requiring devices 16 be synchronized to the same clock (such as is required in a GPS scenario), and provides for a low cost, easy-to-maintain system that does not require calibration of all devices' clocks relative to a standard clock.

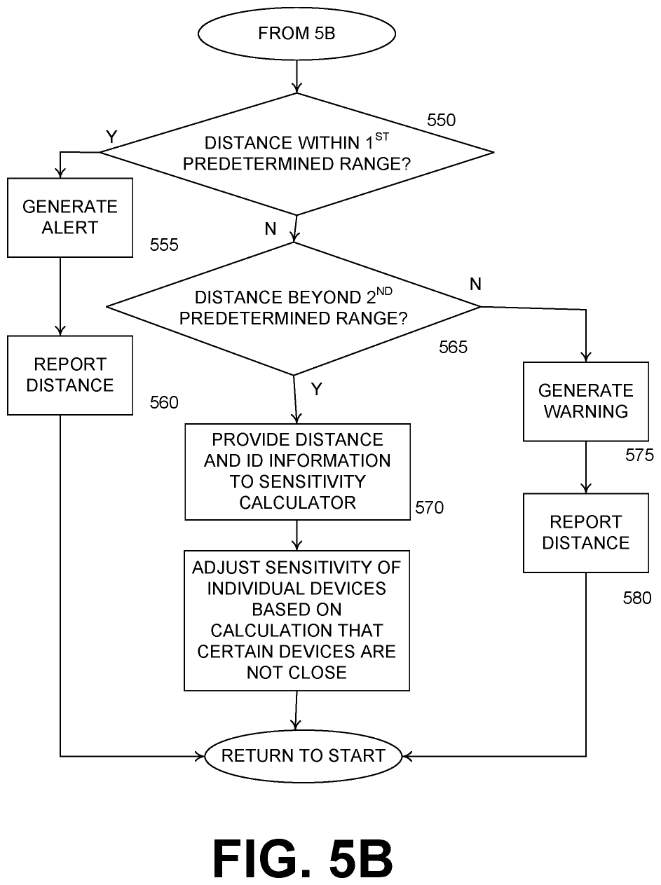

Turning now to FIG. 5 (which is shown on two sheets 5A and 5B), the figure illustrates a method 500 for determining separation of wireless devices, which when worn or carried by individuals, indicate separation of the individuals. Method 500 may be implemented by a computer program running on a processor of a wireless electronic communication device, and starts at step 501. At step 505 a given wireless electronic communication device monitors electronic signals. At step 510 the given wireless electronic device receives electronic signals and determines a receipt time of the electronic signal as being t₀. Electronic signals may be transmitted by other wireless electronic communication devices via a short-range wireless protocol such as, for example, Bluetooth. At step 515 receiving wireless communication device stores the time of receipt to that it determined and step 510 into a memory. At step 520 wireless electronic device that received the signal at step 510 retrieves identification information from the electronic signal that it received at step 510. The identification information corresponds to a wireless electronic communication device that transmitted the signal that was received at step 510. The identification information may include a Bluetooth friendly name, a serial number, a MAC address, or other information that uniquely identifies the transmitting device.

At step 525 the wireless electronic communication device that received the electronic message at step 510 receives an acoustic signal that was transmitted by the same wireless communication device that transmitted the electronic signal that was received in time T₀. The wireless electronic device that receives the acoustic signal establishes the receipt time of the acoustic signal as time Ti.

At step 530 the receiving electronic device retrieves identification information from the acoustic signal. At step 535 the receiving electronic device compares identification information retrieved from the acoustic signal to identification information retrieved from the electronic signal. If a determination is made at step 540 that the identification information retrieved from the acoustic signal does not match the identification information retrieved from the electronic signal method 500 returns to step 525. If a determination is made at step 540 that the identification information retrieved from the acoustic signal matches the identification information retrieved from the electronic signal, method 500 advances to step 545.

At step 545 the receiving electronic device calculates the distance between itself and the device that transmitted both the electronic signal that was received at step 510 and the acoustic signal that was received at step 525. The calculation may be based on the time difference between the receipt time of the electronic signal and the receipt time of the acoustic signal. This time difference may be multiplied by the speed of sound to determine the distance between the transmitting and the receiving device. In an aspect neither the electronic signal nor the acoustic signal (which may be a signal in an ultrasonic range) include a time stamp provided by the transmitting electronic communication device. The determination of time is established by the receiving device based on evaluation of the time of receipt of each of the electronic and acoustic signals.

In an aspect, a receiving device 16 may assume that another device 16 may transmit presence message at a predetermined, preconfigured, or at least steady rate. After one or two electronic and corresponding acoustic messages have been received at a given rate from a given device, the receiving device may assume that that the transmitting device will continue transmit acoustic messages at the same rate and thus may determine a distance to the given transmitting device solely based on receive time of an acoustic message even if a corresponding electronic presence message is not received from the transmitting device from the receiving device. In step 550 method 500 determines whether the distance from the transmitting device to the receiving device is within a first predetermined range. If yes method 500 advances to step 555. And step 555 the receiving device may generate an alert such as a predetermined number of vibrations, a predetermined alert tone, or some other means of alerting a user of the receiving device such as a flashing light. The first predetermined range may be a configurable value, or values, and may be set, for example, as a boundary having a radius equal to a regulated separation distance, such as a minimum social distancing requirement of individuals staying separated by a certain amount, such as, for example, six feet. After generating and providing the alert at step 555 method 500 advances to step 560 and reports the determined distance to a central administration server, such as server 52 shown in FIG. 1, or a cloud server located remotely from the location of the transmitting and receiving devices. After reporting at step 555 the alert and the distance determined at step 545, method 500 returns to step 501 shown in FIG. 5A.

Returning to description of step 550 if a determination is made that the distance between the transmitting device and receiving device is not within the first predetermined range method 500 advances to step 565. At step 565 a determination is made whether the distance determined at step 545 is beyond a second predetermined range or limit. For example, if a regulated minimum social distancing boundary requirement is six feet and is set to establish a first predetermined distance of six feet of separation between individuals, a second predetermined range may be a range of greater than six feet but less than fifteen feet from one individual to another. If a determination is negative at step 565 that the distance determined at step 545 is not beyond the second predetermined range (in other words if transmitting electronic device is not farther away from a receiving device than the outer boundary of the second predetermined range) then method 500 advances to step 575. At step 575 a processor of the receiving electronic communication device generates a warning as compared to an alert that was generated at step 555. The warning generated at 575 may include a number of vibrations that is different from the number of vibrations generated as the alert at step 555, or may be a different tone than generated at step 555, or may be a different light or a different number of light flashes then generated at step 555. At step 580 the processor at the receiving device reports the distance to the administrative server and returns to step 501 as shown on FIG. 5A.

If a determination is made at 565 that the distance determined at step 545 is within the predetermined second range (in other words the distance from a transmitting device to the receiving device is farther than the outer boundary of the first predetermined range but is not outside the boundary of the second predetermined range) method 500 advances 570. At step 570 the distance and the identifier contained in the electronic and acoustic messages sent by the transmitting device is provided to a learning algorithm, or a learning model, or other form of artificial intelligence algorithm for processing. The processing of the artificial intelligence algorithm may be performed at administrative server 52 as shown in FIG. 1 and may be used to exclude processing of messages received from transmitting devices that are farther from a given receiving device then the outer boundary of the second predetermined range relative to the receiving device. Such a determination to exclude a device may be based on determining identifier information 58 in an electronic message received from a transmitting device such that the receiving device need not perform any calculations to determine distance to such an excluded transmitting device after providing the distance determined at step 545 to administrative server 52, unless the server notifies the receiving device to begin processing acoustic signals received from a previously excluded transmitting device. In an aspect, the artificial intelligence algorithm for automatically calculating and determining devices to exclude may be performed by a given device 16. After performance of step 570 method 500 returns to step 501 shown in FIG. 1.

In an aspect, electronic message signal receive sensitivity for a given device 16 may be reduced when more than a predetermined number of electronic/Bluetooth signals are received without corresponding acoustic/ultrasonic signals. This may occur when electronic signals such as Bluetooth have a longer range than ultrasonic signals due to barriers that attenuate the acoustic signals but that do not attenuate the electronic signals. Accordingly, a given device 16 may determine to reduce its receive sensitivity such that it does not perform steps 505-520 of method 500 for electronic signals for which it is not likely to receive a corresponding acoustic signal at step 525.

In an aspect, a given device 16 may determine to increase its electronic message signal sensitivity when it receives an acoustic/ultrasonic signal at a given iteration of step 525 for which it did not previously receive an electronic signal at step 510 that included identification information 58 that matches identification information that the message transmitted in the particular acoustic signal was received at the given iteration of step 525. This may be determined when a given device has received and processed steps 525-540 more than a configurable predetermined number of iterations without having also received matching electronic signals at step 510 as determined in performing the predetermined number of iterations of step 540.

What is claimed is:

1. A method, comprising:
transmitting from a device an electronic presence signal that includes an initial indication;
transmitting from the device an acoustic presence signal that includes an initial indication; and
wherein the device transmits one of the electronic presence signal or the acoustic presence signal a predetermined transmit sequence period after transmitting the other of the electronic presence signal or the acoustic presence signal.

2. The method of claim 1 wherein the electronic presence signal is short-range wireless signal and the acoustic presence signal is in an ultrasonic range.

3. The method of claim 1 wherein the predetermined transmit sequence period is a predetermined number of clock increments of a processor of the device.

4. The method of claim 3 wherein the predetermined number of clock increments is a small value such that the transmission of the electronic presence signal and the transmission of the acoustic presence signal occur substantially simultaneously such that an actual transmissions of the electronic presence signal and the acoustic transmission signal occur within less than 1 microsecond (μS) of each other.

5. The method of claim 3 wherein the predetermined number of clock increments is a value such that the transmission of the electronic presence signal and the transmission of the acoustic presence signal occur greater than 1 millisecond (mS) from one another.

6. A method, comprising:
receiving with a second device at an electronic presence signal receipt time an electronic presence signal transmitted from a first device, wherein the electronic presence signal includes an initial electronic presence signal indication that corresponds to the electronic presence signal receipt time;
receiving with the second device at an acoustic presence signal receipt time an acoustic presence signal transmitted from the first device, wherein the acoustic presence signal includes an acoustic presence signal initial indication that corresponds to the acoustic presence signal receipt time;
wherein the first device transmitted one of the electronic presence signal or the acoustic presence signal at substantially simultaneously the same transmit time; and
determining with a processor of the second device a time difference between the electronic presence signal receipt time and the acoustic presence signal receipt time.

7. The method of claim 6 wherein the electronic presence signal indication is the leading edge of a pulse signal.

8. The method of claim 6 wherein the acoustic presence signal indication is the leading edge of a pulse signal.

9. The method of claim 6 wherein each of the of the electronic presence signal and the acoustic presence signal include transmit device identifier information that corresponds to the first device that transmitted the electronic and acoustic presence signals.

10. The method of claim 6 further comprising providing with the second device an alert message that indicates when an actual separation distance between the first and second devices are within a predetermine first separation distance of one another, wherein the processor of the second device further calculates the actual separation distance based on the time difference between the electronic presence signal receipt time and the acoustic presence signal receipt time.

11. The method of claim 6 further comprising the processor decreasing an electronic message signal receive sensitivity based on receiving a predetermined number of acoustic signals from other devices that each transmitted respective corresponding electronic and acoustic presence signals during a predetermined sample period that preceded the receiving of the electronic and acoustic presence signals from the first device such that processing of received electronic signals transmitted from a number of devices that exceeds a configurable predetermined number during the predetermined sample period and that are not within a second predetermined separation distance of the second device is reduced, wherein the second predetermined distance is greater than a first predetermined separation distance and wherein the first predetermined distance is a predetermined minimum social distancing requirement.

12. The method of claim 11 wherein the processor of the second device is not synchronized with a processor of the first device.

13. A wireless communication tracking device, comprising:
a processor to:
receive at an electronic presence signal receipt time an electronic presence message signal transmitted from another wireless communication tracking device, wherein the electronic presence message signal includes an initial electronic presence message signal indication that relates to the electronic presence message signal receipt time;
receive at an acoustic presence signal receipt time an acoustic presence message signal transmitted from the other wireless communication tracking device, wherein the acoustic presence message signal includes an acoustic presence signal initial indication that relates to the acoustic presence signal receipt time;
wherein the other wireless communication tracking device transmitted one of the electronic presence message signal or the acoustic presence message signal at substantially simultaneously the same transmit time as the other presence message signal; and
determine a time difference between the electronic presence message signal receipt time and the acoustic presence message signal receipt time.

14. The wireless communication tracking device of claim 13 wherein the electronic presence signal initial indication is the trailing edge of a pulse signal waveform.

15. The wireless communication tracking device of claim 13 wherein the acoustic presence signal initial indication is the trailing edge of a pulse signal waveform.

16. The method of claim 13 wherein each of the of the electronic presence message signal and the acoustic presence message signal include transmit device identifier information that corresponds to the other wireless communication tracking device that transmitted the electronic and acoustic presence message signals.

17. The wireless communication tracking device of claim 13 wherein the processor is configured further to provide an alert message that indicates when an actual separation distance between the other wireless communication tracking device and the wireless communication tracking device are within a predetermine first separation distance of one another, wherein the processor is configured further to calculate the actual separation distance based on the time difference between the electronic presence signal receipt time and the acoustic presence signal receipt time.

18. The wireless communication tracking device of claim 13 wherein the processor determines a distance to the other wireless communication tracking device based on receive time of the acoustic presence message signal even when a corresponding electronic presence message signal is not received from the other wireless communication tracking device.

19. The wireless communication tracking device of claim 13 wherein the determination of the distance to the other wireless communication tracking device based on receive time of the acoustic presence message signal is made based on electronic presence signal receipt times of a plurality of earlier-received presence message signal couples.
